(19) United States
(12) Patent Application Publication
(10) Pub. No.: US 2007/0250394 A1
(43) Pub. Date: Oct. 25, 2007

(54) System and method for ordering and producing a paper product with third party graphics printed thereon

(76) Inventor: Hideyuki Isowa, Kasugai-shi (JP)

Correspondence Address: BRINKS HOFER GILSON & LIONE, P.O. BOX 10395, CHICAGO, IL, 60610, US

(21) Appl. No.: 11/409,550

(22) Filed: Apr. 20, 2006

(51) Int. Cl. G06Q 30/00

(52) U.S. Cl. 705/26

(57) ABSTRACT

A system and method of selling free space on a printed sheet to a third party. A first party producer of the sheet, or box made therefrom, maintains a computer readable data base of second party orders for boxes having printable areas thereon, where one or more of the areas are available for use by third party printed matter. The third party may specify requirements for free space, which including characteristics of the free space, box characteristics, and time period of use of the box. The first party may accept orders for the free space on second party box orders, receives the images from the third party and print the images on a printed sheet using an ink jet printer.

### TECHNICAL FIELD

This application relates to system and method for ordering and producing paper products with printing thereon, and more specifically products where the image is specified by a third party.

### BACKGROUND

Public display advertising is used in the marketing and sale of many products to users. Such advertising may be displayed in billboards, placards mounted to the outside or inside of public buses, trains and the like, as well as posters affixed to walls, and the like. The geographical scope of coverage of these advertising means is ordinarily limited to the direct line of sight between the potential customer and the printed display medium. At best, the trains and buses cover a local geographic area. Such advertising means do not provide selectivity of the audience to which they are directed, except geographically, do not address customers who are known consumers of related products, and the number of views of each advertisement is not easily quantified.

A means of ordering and producing specifically targeted printed advertising which may be available for public viewing is needed. This advertising may be printed on sheets which may be displayed flat or folded to from a box.

Corrugated cardboard sheets or similar paper products intended for incorporation into packing or shipping boxes and containers may be printed by ink jet technology, as disclosed in the related US patent applications mentioned above. Presently, two differing technologies may be used for ink jet printing. One technology is a thermal-type print head in which a bubble is formed inside a nozzle to eject the ink droplet toward the surface to be printed, and a second technology is a piezoelectric type in which the ink droplet is produced in response to the vibration of the ink orifice.

Where ink jet technology is used for printing a surface, such as the surface of a corrugated cardboard sheet used to form a box, the sheet width may be wide; as an example about 1500 mm. The ink jet printer for such widths may have a plurality of ink jet print heads, each ink jet print head having a plurality of ink jet nozzles oriented in a linear fashion. Such ink jet heads may have several rows of nozzles, each associated with a specific color, such as the ink colors yellow (Y), magenta (M), cyan (C), and black (K) as are used in a printing process.

The ink jet print heads are disposed in a widthwise direction so as to span the entire width of the surface to be printed. The jet print heads may be controlled by one or more process computers so as to eject the ink droplets to produce a desired image. The ink jet heads are fixed in position and the surface to be printed is advanced at a predetermined feeding rate so that the ink droplets can impinge thereon to form dots thereon and thus create the printed image.

The image data to be printed by the ink jet printer is provided to the printer controller in digital format. As such, multiple images may be transmitted for printing on various portions of the sheet corresponding to faces of a box. The image data may be rapidly be replaced by new image data to change the printing being produced. As such, printing may be adapted to customer requirements by changing the image data supplied to the process controller.

### SUMMARY

A system for producing a printed sheet is described, including a server computer configured to access a first data base of second party orders stored on a computer readable medium. The first data base includes free areas specified in the second party orders. The server may have a communications interface for receiving third-party-specified requirements for free areas, and the first data base is searchable to determine the specific second party orders meeting the third-party-specified free area requirements.

A method of accepting orders for printing on a free area of a sheet is described, the method including: providing a computer readable first data base of orders from a second party; searching the first data base using order characteristic criteria supplied by a third party over a communications interface; transmitting search results to the third party for orders in the first data base meeting the supplied order characteristic criteria; and accepting a third party order for printing on the free area of the sheet for one or more of the second party orders in the first data base.

A method of placing an order for printing on a free area of a sheet is described, the method including: requesting data regarding available free areas of sheets being produced for another; receiving data regarding available free areas of sheets being produced for another through a communications interface; selecting one or more of the available free areas; and placing an order for the printing of the free area.

### BRIEF DESCRIPTION OF THE DRAWINGS

FIG. 1 is a block diagram of the system, showing the first party equipment including the printing apparatus, the third party ordering station and the second party ordering station and a network connection;

FIG. 2 shows a representative image of a sheet for forming a box and having a free space area indicated thereon;

FIG. 3 shows a format for a computer monitor screen which may be used to express the third party free space and other requirements;

FIG. 4 shows a format for a computer monitor screen which may be used to display the results of a search made using the criteria shown in FIG. 3;

FIG. 5 shows a format for a computer monitor screen which may be used as a log-in and validating step in an ordering process; and

FIG. 6 shows images and data which may be displayed to a third party for a regular slotted container (a) and for a telescoping container (b).

### DETAILED DESCRIPTION

Exemplary embodiments may be better understood with reference to the drawings, but these embodiments are not intended to be of a limiting nature. Like numbered elements in the same or different drawings perform equivalent functions.

A system and method for ordering and producing a paper product, which may be a corrugated paper sheet for forming into a box for packaging or shipping of an enclosed product is described, where at least a portion of the sheet corresponding to a face or surface of the box is printed with images selected and ordered by a third party. Generally, the term “third party” is intended to describe a business entity different from the producer of the printed paper sheet, or the sheet to be formed into a box (a “first” party), and the producer of the product to be shipped or stored in the box (a “second” party). In some instances, the third party may be part of the second party entity and may be using the box for a first product to advertise a second product, a service, or the like. Although the term “third party” is used for convenience in the discussion, there is not the intention to require that three independent business entities are unrelated to each other. Different persons, departments, or the like may equivalently be represented.

In many shipping and storage uses of a box or container, the box is manufactured with printed matter on one or more surfaces of the box. Such material is specified by the producer of the products to be contained in the box, and in the case of regulatory information, the producer of the box or the sheet to be formed into a box. Boxes may have printing on some or all of the exterior surfaces; however, in some instances not all of the sides of the box are printed, or not all of the sides of the box must necessarily be printed. Such a circumstance may provide for one or more box surfaces whose printed content may be specified by a third party, and be printed on the sheet from which the box is to be made, either at the same time as the second party printed material, or separately.

The costs of manufacturing the box, printing the box and other costs may be defrayed by selling the unused space on the box for the display of third party printed matter as advertising. Herein, a system and method of identifying opportunities for the use of unused space (“free space” or “free area”) of the surfaces of the box space, and facilitating the placement of orders for printing on such free space is disclosed.

In an aspect, the first party accepts orders for boxes from a second party. The specifications of the boxes ordered may include the size, configuration, liner material, color material, strength, and the like, and the second party, as the customer of the first party, specifies the printed matter to be placed on the various surfaces of the box. To the extent that the second party wishes to participate in or authorize the use or sale of free space on boxes used for the products of the second party, one or more surfaces of the box are left blank, or the printing on one or more designated surfaces of the box may be replaced by advertising printed matter specified by a third party.

Systems and methods for ordering the box from the first party by the second party are described in the related applications mentioned, as well as a apparatus and method for producing the sheets to be formed into a box with a flexible printing process using ink jet technology. As a consequence of the ordering and producing of printed sheets for boxes, the order data base of the first party (the box producer) may contain information about the type of product to be shipped or stored in the box, the size and configuration of the box, identification of the corporate entity of the first party, production and shipping schedule, quantity ordered, and the like. Some or all of this information may be useful to a third party in identifying advertising opportunities.

In an aspect, the third party space requirements may be entered into a data base of the first party. These needs may specify the type or category of product or services to be advertised, the time period where the advertisement would be first available to the public, the number of boxes to be produced with the advertising material printed thereon or the total price or cost. As previously defined, the first party is the producer of the printed sheet or box, the second party is the user of the sheet or box and the third party is the entity purchasing or specifying the content of the advertising space on the box, and placing the order for such space. The third party advertising requirements data base may then be compared with a multiplicity of orders placed by second parties to determine compatibility between the availability of space and the requirements of the third party. Where such compatibility exists, orders for use of the available free space for printing may be either automatically executed or the availability of space communicated to the third party so that a decision on placing an order may be made. Whether the space commitment is automatic or requires confirmation would be a customer preference specified in the second and third party information. As there is the possibility for commercial conflict in the placement of a third party advertisement on a box containing the product of a second party, the second party may require that a confirmation that the advertisement is acceptable be provided by the second party to the first party prior to acceptance of the order from the third party.

In another aspect, some or all of the information in the order data base that is relevant to the purchasing of advertising space may be made searchable by a third party. In this circumstance, the third party may access the data base by specifying parameters on a web page search form, or using a specially designed display format, so as to initiate a data base search of the order data base to identify records meeting the search criteria. The data base search engine may be any of the variety of such engines as are known in the art and may be found in web-based access applications. For commercial security, only known users having a valid user name and password may be provided with access to the order data base, and the connection between the first party and the second party order data base may be made through a server and using encrypted connections as are known in the art.

Instructions for managing the data bases at the several parties, the searching of the data bases, selection of advertising space, the ordering of advertising space and the manufacturing processes for producing the printed sheet for the box, and the like, may be provided on computer-readable storage media or memories, such as a cache, buffer, RAM, removable media, hard drive or other computer readable storage media, and executed by servers, computers or processors. The terms server, computer, processor and the like are used equivalently in the art and that practice is continued herein.

Computer readable storage media include various types of volatile and nonvolatile storage media. The functions, acts or tasks illustrated in the figures or described herein may be executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, data processing strategies may include multiprocessing, multitasking, parallel processing and the like. In an aspect, the instructions may be stored on a removable media device for reading by local or remote systems. In other aspects, the instructions may stored in a remote location for transfer through a computer network, a local or wide area network or over telephone lines. In yet other aspects, the instructions are stored within a given computer or system.

To support multiple users at geographically distributed locations, web-based applications and devices may be used. Where the term “web”, “network” or “Internet” is used, the intent is to describe an internetworking environment, which may include both local and wide area networks, where defined transmission protocols are used to facilitate communications between diverse, possibly geographically dispersed, entities. An example of such an environment is the world-wide-web and the use of the TCP/IP data packet protocol, and the use of Ethernet or other hardware and software protocols for some of the data paths. The terms server, computer, processor and the like are used equivalently in the art and that practice is continued herein.

In the examples, the third party may also be considered to be a division or other business entity or staff organization of the second party having a need to place printed matter on boxes to be used for storage or shipment of products being manufactured by the second party. The printed matter may relate, for example, to other products produced by the second party, to services provided in conjunction with the product to be enclosed in the box, or to other products, to special sales programs, discounts, new product announcements and the like. Each of these requirements may have time periods where the announcement is premature, such as before the product to be advertised has been publicly announced, and other time periods where the announcement is stale or out of date. Such criteria may form the basis for the search fields, along with information on the type, size, configuration and construction of the box which may be relevant to a decision on the placement of an image on the side thereof having free space.

As used herein, a corrugated sheet is intended to mean any structure having at least a liner and a corrugated structure, the liner and the corrugated structure being integral or co-joined by a fixation means such as an adhesive an interlayer or the like. Such corrugated sheets are commonly made from cellulose-based materials, but as used herein the term is not intended to exclude other materials such as plastics, staple fibers, or other combinations of materials that may be formed into sheets. A corrugated structure has a minimum of a liner and a corrugated structure, but may include multiple layers of each type and with various means of joining the layers together.

A sheet may be a corrugated sheet, a flat sheet, a flat sheet with a corrugated sheet affixed to one surface, a corrugated sheet having flat sheets affixed to opposing surfaces thereof, on combinations of such arrangements. The corrugations may be sinusoidal, crenellated, triangular or the like. The sheet may be cellulose-based, plastic, fibrous or the like and may be a combination of a variety of materials such that a surface suitable for printing is formed.

An image may include a picture, a drawing, a geometric or abstract design, including text, and be of one or more colors, and an image may consist of a single solid color. More than one image may be combined for printing on a surface or a face of the box or container.

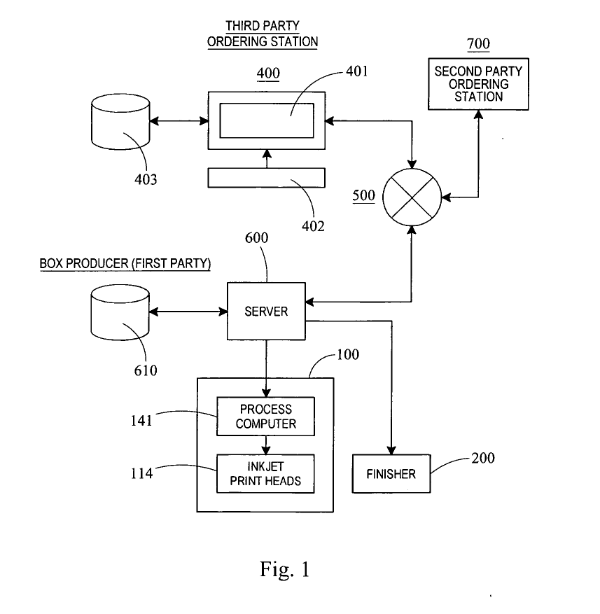

FIG. 1 illustrates a portion of the system and method, comprising a third party ordering station, which may also be termed a client or user, having a computer 400, interfacing with a communications network 500, the communications network 500 interfacing with the producer through a server 600. The computer 400, for use by the client may further comprise a display and central processing unit 401, a keyboard 402 and a mass storage medium 403. The computer may be a personal computer, or any equivalent thereof, and have a range of accessories (not shown) including a mouse, auxiliary storage, displays, and the like. The interface between the computer 400 and the network 500 may be a wired or wireless connection. The network may be any of a local area network (LAN), an intranet, a wide area network (WAN) such as the Internet, or a wireless interconnection, or a combination of any or all of the types of communications networks, so as to serve as a data connection between the customer and the producer.

The second party customer for the box, who may be a producer or distributor of the product to be stored and shipped in the box, may place an order for boxes through a second party ordering station 700, which has the same or similar capabilities as the third party ordering station which has been described. The second party places an order for boxes which may, specify size, configuration, construction details, quantity, and delivery date, in addition to the specific matter which is to be printed on the surfaces of the box. In the situation where one or more sides of the box, or the interior thereof is to be made available to a third party (where the third party may be an activity of the second party), such information as the location of the surfaces that are available, the type of product which will be contained in the box, the projected shipping date of the assembled box and product, acceptable types of third party printed matter, and the like may also be supplied. All or a subset of the information provided by the second party may be made available to the third party through a automated or interactive search of the second party order data base. The selection of the categories of information, and the detail of the information to be provided regarding the order may be altered for third parties not associated with the second party. In addition, the access by a third party to the data base of orders maintained by the first party may be on a read-only basis.

At the producer location, a server or computer 600 has an interface to the network 500 and executes a compatible software protocol to establish and maintain communications with the client or user, which may be a second or a third party. A mass storage device 610, which may be any of the known types of memory, is connected to the server 600. The mass storage device may contain the data bases needed to perform the functions described herein, which may include the second party order data base for the boxes, a subset data base of the second party order data base which is accessible to third parties, a third party data base which may contain information as to specific needs of the third party for material to be printed on first party boxes, and a third party data base which contains orders for the printing of material on second party boxes. This may permit third-party specified advertising requirements to be compared with available space in the order data base on a requested or periodic basis in order to determine if the requirements can be fulfilled. Naming a data base does not imply that the data may not be stored in a composite data base where individual fields have specified access restrictions, the merging of data bases, the querying of multiple data bases, and the like.

Naming of the data base is convenient for discussing some functional aspects as may be perceived by a person, but is not intended to suggest a limitation on the way in which the actual data is stored and processed.

The server 600 further interfaces with an ink jet printer 100, the ink jet printer having a print controller 141. A control signal is transmitted from the server 600 to the ink jet printer 100. This may include the conversion of red (R), green (G), blue (B) data representations normally used to display images on a visual display such as a computer monitor to the yellow (Y), magenta (M), cyan(C) and black (K) format which may be used for printing. Alternatively, the representations may be converted in the print controller 141. A finisher 200, which may be comprised of a creaser and a slotter may be connected to the server 600. Alternatively the server may display or print instructions for operators regarding the operation of the finisher 200, and the steps needed to perform the setup and the operation of the finisher may be performed either manually or automatically.

In an aspect, the printed image including the image specified by the first party and the image for the free area specified by the third party may be printed on the sheet in one printing operation, or only the image specified by the third party may be printed on the free area of the sheet on which the image by the first party may have already been printed.

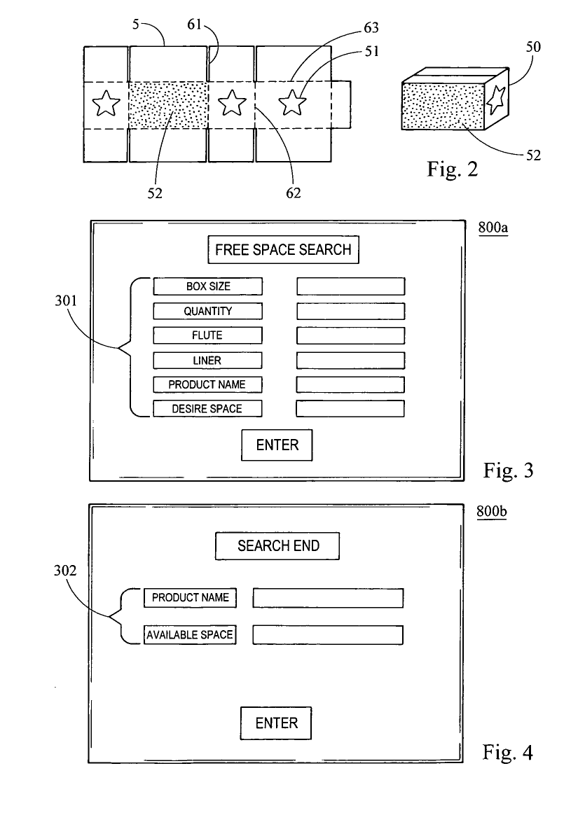

FIG. 2 is an example of a box whose characteristics are maintained in the second party order data base, showing a box having three sides where the printing has been specified by the second party as the user of the box, and shown schematically by stars 51, and a side where the second party may permit a printed message or image to be inserted by a third party shown as a lined area 52. For example, in a case where the products to be shipped by the box are apples produced by the second party, stars 51 may be an image of the apple, while the printed message for the free area may be related to an apple jam produced by the third party. The box is shown both in the form of the sheet 5 that will be produced by the first party, including slots 61, creases 62 and scores 64, as well as a perspective view of a completely assembled box 50.

FIG. 3 is an example of a computer monitor screen 800a which may be used by the third party to query the order data base to determine whether suitable space is available. This query may be performed by manually entering the information on the screen, or by storing space requirement information in a third party data base on the mass storage medium 610 so that the query may be run multiple times until either the time period specified by the third party has expired or the space requirement is fulfilled. In the examples presented, a manually controlled search is described, but an automatic search performing at least the functions described is equally possible.

The third party ordering station screen 401, may have a variety of different and customizable search field inputs which may be particular to the needs of the third party. Only a sample of such search fields are shown herein, and which may include box size, quantity, characteristics such as flute and liner, product type, amount of space desired and time period of availability. Other search criteria have been mentioned in this specification, and the choice of such criteria may depend on the users, the industry of the products, and the like. The search may be initiated by clicking on an enter button, pressing the enter key or return key on the keyboard 402, or any similarly acting input device or method. The search request is sent from the ordering station 400 to the server 600 over a network 500, which may be the Internet, a LAN, a WAN, a wireless connection or the like, so that the ordering station 400 and the server 600 may not be co-located.

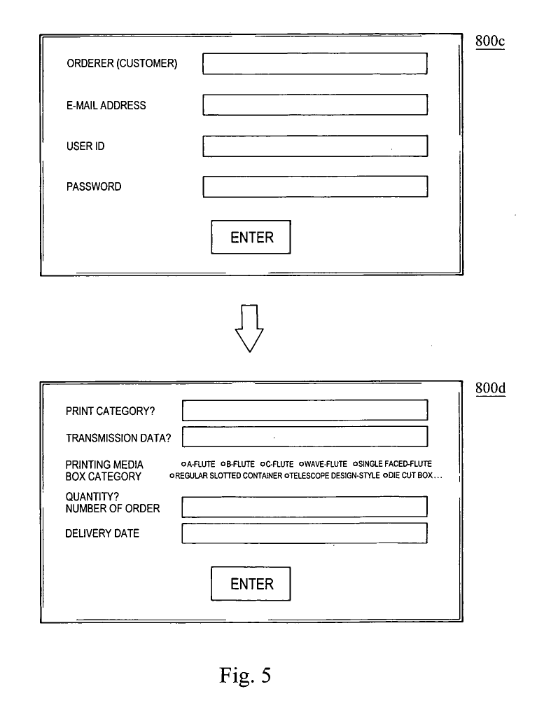

Upon receipt of the search request, the server 600 performs the functions of searching the appropriate data bases stored on mass storage medium 610 and formats the results of the search for transmission over the network 500 to be displayed at the ordering station 400 on the display 401.

Where the search returns one or more first party orders which are suitable for the purposes of the third party and which may be displayed on a search results screen 800b, as shown in FIG. 4, an order may be placed for the printing on the free space 52. In placing such an order, it may be required that the third party user access a log-in screen 800c as shown in FIG. 5, where such identifying information as customer number, user ID and password are required. Such information is then sent over the network to be validated by the server 600, and an ordering screen having ordering information 800d presented to the user. All of the information may be entered manually, however as the results of the search may have presented much of the information needed to complete the ordering process, such information may be entered automatically on the form, subject to validation or change by the user.

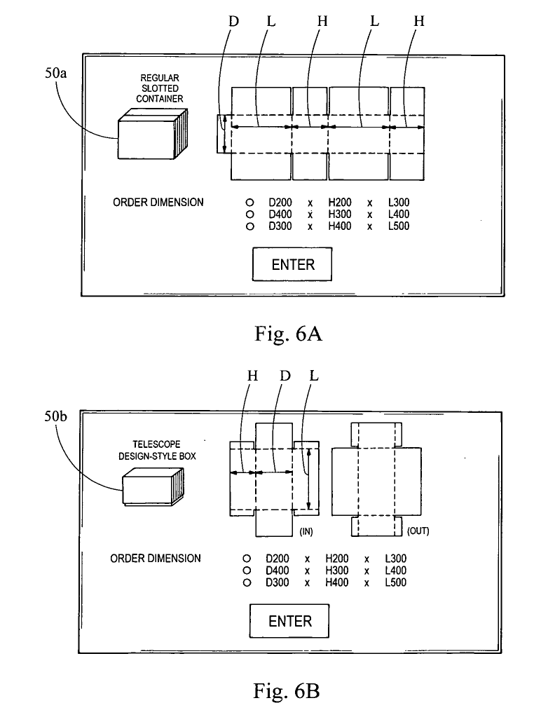

As part of the search and decision making process, the ordering station 400 may display representations of the sheet and box type available, and may also indicate the surface of the box where third party ordered printing may be placed. FIG. 6 a shows a developed outline image of a regular slotted storage container 50a where the available dimensions are indicated. Similarly, a telescoping design style box 50b is shown in FIG. 6b. In this example, the box is produced in two pieces, where the cover of the box is sized and dimensioned to fit over the remainder of the box to form a top closure. Other box styles may be similarly displayed so that the user may visualize the configuration, however, the user may order the printing without the need to display an image such as the developed outline image.

A method for accepting orders for printing on a free area or space of a box or shipping container includes: establishing and maintaining a data base of second party orders for boxes, including at least the identification of one or more areas of the box which may be available for printing of information or images specified by a third party; accepting requests from a third party seeking to order the printing of images on free areas of second party boxes; searching the data base of second party orders so as to identify second party orders meeting the third party ordering criteria; transmitting the information relating to available free areas meeting the search criteria to the third party; and receiving an order for printing from the third party.

A method of ordering printing of third party supplied information or images on a free area of a shipping container ordered by a second party includes: formulating a search request incorporating ordering criteria, which may include but is not limited to: type of box, quantity of boxes, shipping date, and the like; forwarding the search request to a first party capable of providing the service of searching box orders for available free area meeting the search criteria; receiving search results indicating the second party orders having free areas meeting the search criteria; displaying the search results; selecting a search result meeting third-party requirements; and, placing the order by validating, modifying or filling out an order form of the display. The subsequent steps of the manufacturing process may be performed automatically, manually, or by a combination of automatic and manual steps.

In each of the methods, at least one of initiating the searching, the selecting of first party orders for which a third party order for free space is to be associated with, and the third party order placement may be performed automatically. Further, here, as in the discussion of the system, there may be more that one first party, second party and third party. The first party may be an intermediary between the box printer (as the producer first party) and the second and third party. The intermediary may be an advertising agency or advertising sales bureau, which may offer the free space on boxes of more than one box printer (first party) and product manufacturer (second party) to third parties.

Although only a few exemplary embodiments have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A system for producing a printed sheet, comprising:
a computer configured to access a first data base of second party orders stored on a computer readable medium the first data base including free areas specified in the second party orders,
wherein the computer has a communications interface for receiving third-party-specified requirements for free areas, and the first data base is searchable to determine the specific second party orders meeting the third-party-specified requirements.

2. The system of claim 1, wherein a second data base is stored on the computer readable medium, the second data base characterized by containing third-party-specified requirements for free space as received through a communications interface, and the first data base is searchable to determine the specific second party orders meeting the third-party-specified specified requirements.

3. The system of claim 2, wherein the first data base is searched based on the criteria of the second data base.

4. The system of claim 3, wherein the results of the searching of the first data base are transmitted over a communications interface.

5. The system of claim 1, wherein the results of the searching of the first data base are transmitted over a communications interface

6. The system of claim 1, wherein the sheet is configured to be compatible with forming into a box or container.

7. The system of claim 1, wherein the server initiates a printing process of an ink jet printer.

8. The system of claim 1, where the computer is configured to process a third party order based on the search results, and to modify a production data base corresponding to the second party order data base to include a third party order for printing in the free area of the second party order.

9. A method of accepting orders for printing on a free area of a sheet, the method comprising:
providing a first data base of orders from a second party;
searching the first data base using order characteristic criteria supplied by a third party over a communications interface;
transmitting search results for orders in the first data base meeting the supplied order characteristic criteria;
accepting a third party order for printing on the free area of the sheet for one or more of the second party orders in the first data base.

10. The method of claim 9, wherein the sheet is configured to be compatible with forming into a box or container

11. The method of claim 9, further comprising:
formatting the information received from the third party as an order, validating the order, scheduling the production of the order, and providing an acknowledgement of the order to the third party by transmitting an acknowledgement message over the network through the communications interface.

12. The method of claim 9, wherein the communications interface communicates with a network.

13. A method of placing an order for printing on a free area of a sheet, the method comprising:
requesting data regarding available free areas of sheets being produced for another;
receiving data regarding available free areas of sheets being produced for another through a communications interface;
selecting one or more of the available free areas; and
placing an order for the printing of the free area.

14. The method of claim 13, wherein an image or message is displayed for each free area to be printed.

15. The method of claim 13, wherein the data regarding available free areas is displayed in the form of developed outline images of a box or container.

16. The method of claim 13, further comprising:
modulating the request data on a carrier wave and transmitting the carrier wave on a network.

17. The method of claim 15, wherein the individual faces of the developed box outline image are displayed as separate images of individual faces of the box.
